(19) United States
(12) Patent Application Publication
(10) Pub. No.: US 2026/0370456 A1
(43) Pub. Date: Nov. 19, 2026

(54) SYSTEMS AND METHODS FOR CONDUCTING SECURE MUTUAL AUTHENTICATION WITH ASYMMETRIC KEYS

(71) Applicant: ASSA ABLOY AB, Stockholm (SE)

(72) Inventor: Martin Kaufmann, Graz (AT)

(21) Appl. No.: 19/132,131

(22) PCT Filed: Nov. 28, 2022
(86) PCT No.: PCT/EP2022/083450

§ 371 Date: May 22, 2025

(51) Int. Cl. H04L 9/08; H04L 9/32

(52) U.S. Cl. CPC H04L 9/0838; H04L 9/0825; H04L 9/0866; H04L 9/3247

(57) ABSTRACT

In an embodiment, an initiating device and a responding device exchange ephemeral public keys. The initiating device generates a signature that includes a first value and both ephemeral public keys, and that is signed with an initiating-device static secret key. The initiating device calculates a shared secret from the responding-device ephemeral public key and the initiating-device ephemeral secret key, and then generates a symmetric key based on (i) the shared secret and (ii) context-binding identifiers of both ephemeral public keys. The initiating device generates an encryption package that includes the signature and a public-key certificate that includes an initiating-device static public key and a cryptographic signature of a trusted authority, and that is encrypted with the generated symmetric key. The initiating device transmits the encryption package to the responding device. The responding device performs similar complementary operations, and a secure mutual authentication flow is achieved.

### TECHNICAL FIELD

Among other technical fields, embodiments of the present disclosure pertain to security, authentication, encryption, asymmetric encryption, public-key cryptography, public-key certificates, separation of access conditions, and, more particularly, to systems and methods for conducting secure mutual authentication with asymmetric keys.

### BACKGROUND

Data encryption is used for many purposes in today's modern society. One prominent purpose for which data encryption is used is authentication. Generally speaking, authentication is the process by which a person or device establishes (or at least tries to establish) that they actually are the person or device that they represent themselves to be. Communication exchanges related to authentication are often referred to as authentication flows, and include one-way authentication flows and mutual authentication flows. Moreover, various types of encryption exist, including what are known as symmetric encryption and asymmetric encryption.

In a type of asymmetric encryption known as public-key cryptography, devices typically generate or are provisioned with an asymmetric keypair that includes a static (or at least semi-static, semi-permanent, etc.) public key and a static secret key that are mathematically related to one another such that neither the public key nor its corresponding secret key can be derived from the other, and such that a message that is encrypted with one of the two keys can (realistically) only be decrypted using the other of the two keys.

Devices often exchange public keys with one another, while keeping their secret keys private. As stated, communication that is encrypted with a given public key can only be decrypted using the corresponding secret key, and vice versa. As such, a communication (e.g., a message, a document, etc.) that is signed using a given secret key can only have that signature verified using the corresponding public key. As such, public-key cryptography can be used both for encryption of underlying communications and for authentication via signature verification. In some cases, public-key cryptography is used at least in part to establish a symmetric key that both parties to a given communication session can then use to encrypt substantive communications.

Returning to the context of authentication, one commonly used tool for authentication is known as a public-key certificate, which is an electronic document that includes an identity of a given entity (e.g., person, system, entity, organization, etc.) as well as a public key of that entity. Thus, a public-key certificate is an electronic document that “binds” a given public key to an identity of the owner of that public key. A public-key certificate is cryptographically signed by an organization known as a “trusted authority” (or “certification authority”), and often includes data that identifies the particular trusted authority that signed the particular public-key certificate. Example types of public-key certificates include Card Verifiable Certificate (CVC) certificates and X.509 certificates, the latter being based on the International Telecommunications Union (ITU) X.509 standard.

A trusted authority uses the trusted authority's own secret key to cryptographically sign a given public-key certificate. Other devices can therefore use the trusted authority's corresponding public key to verify that the certificate was indeed cryptographically signed by that trusted authority, and accordingly trust that the public key provided in the certificate actually belongs to the entity that is identified in the certificate as being the owner of that public key. The trusted authority, together with its secret key and corresponding public key, may be thought of as the “trust root” of a given public-key certificate.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts an example communication arrangement, in accordance with at least one embodiment.

FIG. 2 depicts an example information-flow diagram, in accordance with at least one embodiment.

FIG. 3 depicts a first cryptography-architecture diagram showing an example initiating-device package-generation process, in accordance with at least one embodiment.

FIG. 4 depicts a second example cryptography-architecture diagram showing an example initiating-device-authentication and responding-device package-generation process, in accordance with at least one embodiment.

FIG. 5 depicts a third example cryptography-architecture diagram showing an example responding-device-authentication and initiating-device symmetric-session-key-generation process, in accordance with at least one embodiment.

FIG. 6 depicts a fourth example cryptography-architecture diagram showing an example responding-device symmetric-session-key-generation process 242, in accordance with at least one embodiment.

FIG. 7A and FIG. 7B together depict a first example method, performed by an initiating device, in accordance with at least one embodiment.

FIG. 8A and FIG. 8B together depict a second example method, performed by a responding device, in accordance with at least one embodiment.

FIG. 9 depicts an example computer system that could be configured to perform at least one embodiment and/or embody one or more devices, systems, and/or the like, in accordance with at least one embodiment.

FIG. 10 depicts an example software architecture that could be implemented on a computer system such as the example computer system of FIG. 9, in accordance with at least one embodiment.

### DETAILED DESCRIPTION

As described herein, one or more embodiments of the present disclosure take the form of methods that include multiple operations. One or more other embodiments take the form of systems that include at least one hardware processor and that also include one or more non-transitory computer-readable storage media containing instructions that, when executed by the at least one hardware processor, cause the at least one hardware processor to perform multiple operations (that in some embodiments do and in other embodiments do not correspond to operations performed in a herein-disclosed method embodiment). Still one or more other embodiments take the form of one or more non-transitory computer-readable storage media (CRM) containing instructions that, when executed by at least one hardware processor, cause the at least one hardware processor to perform multiple operations (that, similarly, in some embodiments do and in other embodiments do not correspond to operations performed in a herein-disclosed method embodiment and/or operations performed by a herein-disclosed system embodiment).

Furthermore, a number of variations and permutations of embodiments are described herein, and it is expressly noted that any variation or permutation that is described in this disclosure can be implemented with respect to any type of embodiment. For example, a variation or permutation that is primarily described in this disclosure in connection with a method embodiment could just as well or instead be implemented in connection with a system embodiment and/or a CRM embodiment. Furthermore, this flexibility and cross-applicability of embodiments is present in spite of any slightly different language (e.g., processes, methods, methodologies, steps, operations, functions, and/or the like) that is used to describe and/or characterize such embodiments and/or any element or elements thereof.

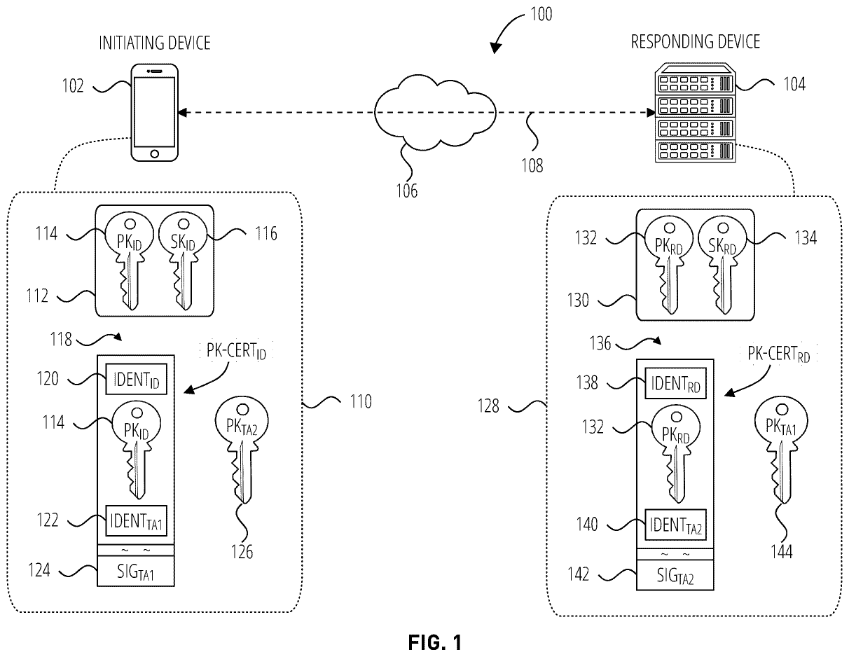

FIG. 1 depicts an example communication arrangement 100, in accordance with at least one embodiment. The communication arrangement 100 is presented by way of example and not limitation, as different configurations, devices, arrangements, and/or the like could be present in various different contexts. As can be seen in FIG. 1, an initiating device 102 communicates with a responding device 104 over a network 106 via a communication link 108.

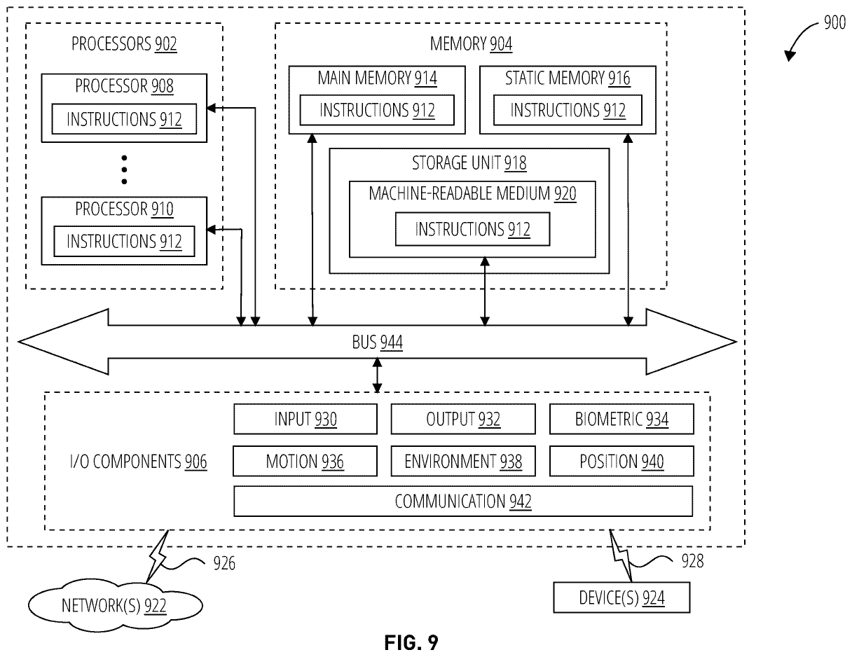

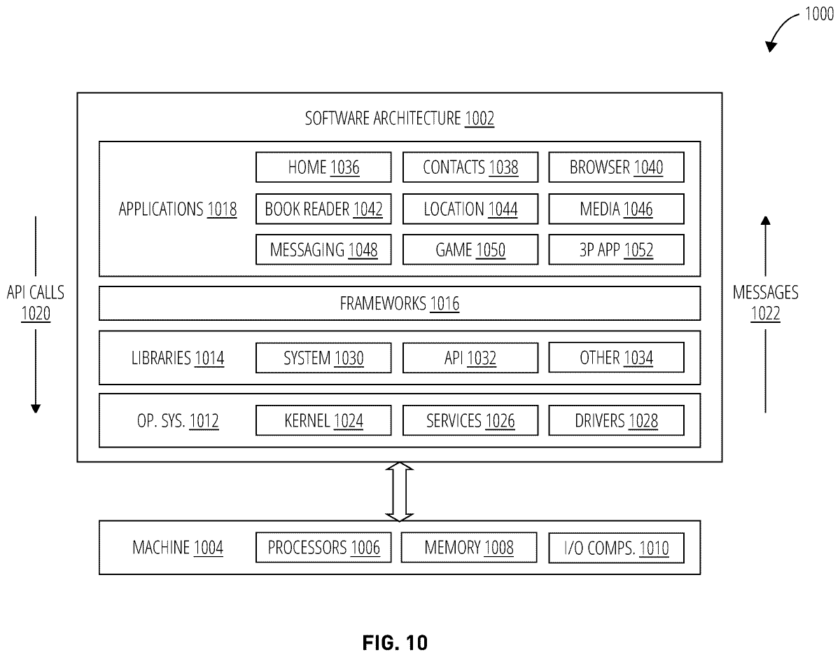

Furthermore, although the initiating device 102 is depicted as a mobile device and the responding device 104 is depicted as a network server, these are just examples. The initiating device 102 could be any of numerous different types of devices, as could the responding device 104. Either or both of the initiating device 102 and the responding device 104 could be a computer system such as the example computer system 900 that is described below in connection with FIG. 9, and could have a software architecture similar to the example software architecture 1002 that is described below in connection with FIG. 10. Generally speaking, any devices that are suitably equipped and programmed to perform the functions described in the present disclosure could be used in various different implementations and contexts.

As a first example, both the initiating device 102 and the responding device 104 could be mobile devices (e.g., smartphones). As a second example, the initiating device 102 could be a reader (e.g., a radio frequency identification (RFID) reader) and the responding device 104 could be an RFID access card (or other access device), where the reader may interface with the access card as part of, for example, a physical access control system (PACS), an electronic access control system (EACS), and/or one or more other types of systems. Numerous other examples could be presented here as well, and will occur to those of skill in the relevant arts having the benefit of the present disclosure. In some standards documents, the initiating device 102 is referred to as an “interface device” (IFD) and the responding device 104 is referred to as the “integrated circuit card” (ICC).

Additionally, any suitable type and number of intermediate devices could be present in the network 106 and/or along the communication link 108 more generally; some example intermediate devices include wireless access points, routers, bridges, base stations, and/or the like. Similarly, the communication link 108 could include one or more wireless-communication links (using, e.g., Wi-Fi, Bluetooth, 5G, LTE, and/or the like) and/or one or more wired-communication links (using, e.g., Ethernet, USB, and/or the like). In some embodiments, the network 106 is not present, in which case the initiating device 102 and the responding device 104 may communicate with one another directly over the communication link 108, which may be a local (e.g., Bluetooth) connection. If present, the network 106 could be or include any combination of one or more wired networks and/or one or more wireless networks.

As depicted by way of example, in FIG. 1, the initiating device 102 may, at a certain point in time, have stored therein what is referred to in the present disclosure as an initiating-device cryptographic dataset 110. In the example of FIG. 1, the initiating-device cryptographic dataset 110 includes:
1. an initiating-device asymmetric keypair 112, which may be generated by or provisioned into the initiating device 102, and which includes an initiating-device static public key 114 (“PK_{ID}”) and an initiating-device static secret key 116 (“SK_{ID}”);
2. an initiating-device public-key certificate 118, which is labeled “PK-CERT_{ID}” in FIG. 1, and which includes:
   a. an identity of the initiating device 102 (i.e., the initiating-device identity 120, labeled “IDENT_{ID}”) or an identity of an owner or operator of the initiating device 102, etc.;
   b. a copy of the initiating-device static public key 114 of the initiating device 102;
   c. an identity of a first trusted authority “TA1” (i.e., the first-trusted-authority identity 122, labeled “IDENT_{TA1}”), although in some embodiments, this element is omitted from the initiating-device public-key certificate 118, and the correct trusted authority is indicated or known in another way; and
   d. a first-trusted-authority cryptographic signature 124, which is labeled “SIG_{TA1}” in FIG. 1, and which corresponds to the initiating-device public-key certificate 118 (including the initiating-device identity 120, the initiating-device static public key 114, and the first-trusted-authority identity 122) having been cryptographically signed by the first trusted authority; and
3. a public key of a second trusted authority “TA2” (i.e., a second-trusted-authority public key 126, labeled “PK_{TA2}”). The first trusted authority and the second trusted authority could be the same trusted authority or two different trusted authorities.

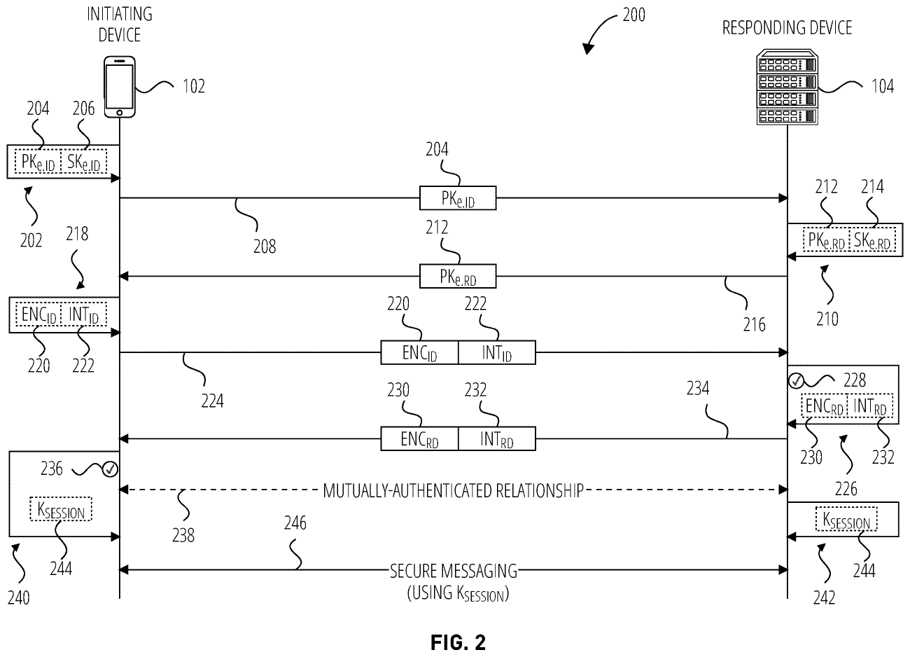

It is noted that the box that has two tilde (“~”) characters in it and is positioned just above the first-trusted-authority cryptographic signature 124 indicates in FIG. 2 that the first-trusted-authority cryptographic signature 124 applies to the dataset that includes the initiating-device identity 120, the initiating-device static public key 114, and the first-trusted-authority identity 122. Thus, in FIG. 2 and in other figures in the present disclosure, a box with two tildes in it is used to indicate that the signature that follows the two-tilde box applies to the preceding information. For horizontally displayed elements, the signature appears to the right of the two-tilde box. For vertically displayed elements, the signature appears below the two-tilde box.

Moreover, as is also depicted by way of example in FIG. 1, the responding device 104 may, at a certain point in time, have stored therein what is referred to in the present disclosure as a responding-device cryptographic dataset 128. In the example of FIG. 1, the responding-device cryptographic dataset 128 includes:
1. a responding-device asymmetric keypair 130, which may be generated by or provisioned into the responding device 104, and which includes a responding-device static public key 132 (“PK_{RD}”) and a responding-device static secret key 134 (“SK_{RD}”);
2. a responding-device public-key certificate 136, which is labeled “PK-CERT_{RD}” in FIG. 1, and which includes:
   a. an identity of the responding device 104 (i.e., the responding-device identity 138, labeled “IDENT_{RD}”) or owner or operator of the responding device 104, etc.;
   b. a copy of the responding-device static public key 132 of the responding device 104;
   c. an identity of the second trusted authority (i.e., the second-trusted-authority identity 140, labeled “IDENT_{TA2}”), although in some embodiments, this element is omitted from the responding-device public-key certificate 136, and the correct trusted authority is indicated or known in another way; and
   d. a second-trusted-authority cryptographic signature 142, which is labeled “SIG_{TA2}” in FIG. 1, and which corresponds to the responding-device public-key certificate 136 (including the responding-device identity 138, the responding-device static public key 132, and the second-trusted-authority identity 140) having been cryptographically signed by the second trusted authority; and
3. a public key of the first trusted authority (i.e., a first-trusted-authority public key 144, labeled “PK_{TA1}”).

Embodiments of the present disclosure relate to mutual authentication flows that make use of the above-described initiating-device cryptographic dataset 110 and responding-device cryptographic dataset 128 that may be stored at a given point in time by the initiating device 102 and the responding device 104, respectively.

FIG. 2 depicts an example information-flow diagram 200, in accordance with at least one embodiment. The various elements that are depicted in FIG. 2 are further discussed in connection with a number of the ensuing figures. As shown in FIG. 2, the depicted communications are between the initiating device 102 on the left-hand side and the responding device 104 on the right-hand side. Moreover, it is noted that the keys and other values that are referred to in the present disclosure as “ephemeral” may be randomly generated (or otherwise mathematically calculated) on as as-needed basis. Ephemeral keys are often referred to as being generated “on the fly.” Other keys and values are referred to in the present disclosure as “static” keys, values, and the like. These static values are typically at least semi-permanent. Of course they can change from time to time, but they are generally persisted as opposed to the transient nature of ephemeral keys and other values.

The information-flow diagram 200 begins with the initiating device 102 performing an initiating-device-ephemeral-keypair-generation process 202, in which the initiating device 102 generates (i.e., “spins up”) an ephemeral keypair that includes an initiating-device ephemeral public key 204 and a corresponding initiating-device ephemeral secret key 206. In a command 208, the initiating device 102 transmits the initiating-device ephemeral public key 204 to the responding device 104. Similarly, the responding device 104 performs a responding-device-ephemeral-keypair-generation process 210 in which the responding device 104 randomly generates an ephemeral keypair that includes a responding-device ephemeral public key 212 and a corresponding responding-device ephemeral secret key 214. In a response 216, the responding device 104 transmits the responding-device ephemeral public key 212 to the initiating device 102.

Thus, the initiating device 102 and the responding device 104, in at least one embodiment, generate ephemeral public keys and exchange these ephemeral public keys with one another in plaintext, readable by any devices or other entities that may be on the communication link 108 between the initiating device 102 and the responding device 104. Because of this plaintext nature of transmission, in at least one embodiment the initiating device 102 and the responding device 104 validate any ephemeral public keys that they receive from the other device. Static public keys can also be validated, though this may be less necessary due to the use of public-key certificates as described herein.

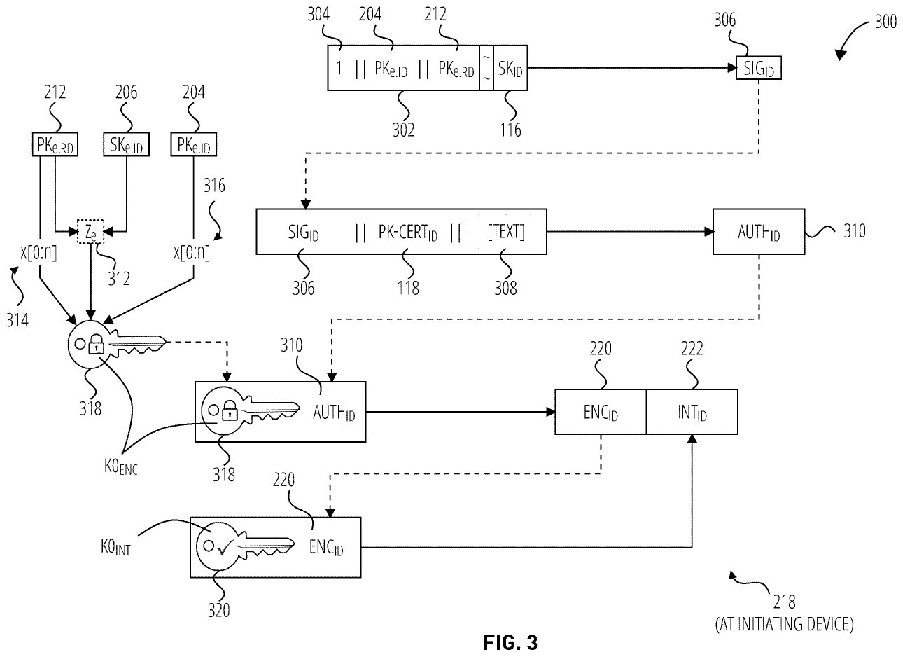

Next, the initiating device 102 performs what is referred to herein as an initiating-device package-generation process 218, which is further discussed in connection with FIG. 3. As explained more fully below, the initiating-device package-generation process 218 includes the initiating device 102 generating what are referred to in the present disclosure as an initiating-device encrypted package 220 and an initiating-device-encryption-package integrity data 222. The initiating device 102 sends a command 224 to the responding device 104, and the command 224 includes the initiating-device encrypted package 220 and the initiating-device-encryption-package integrity data 222. The contents of these data items in some embodiments are discussed below. Generally speaking, any suitable form of encryption and data-integrity information can be implemented in connection with embodiments of the present disclosure.

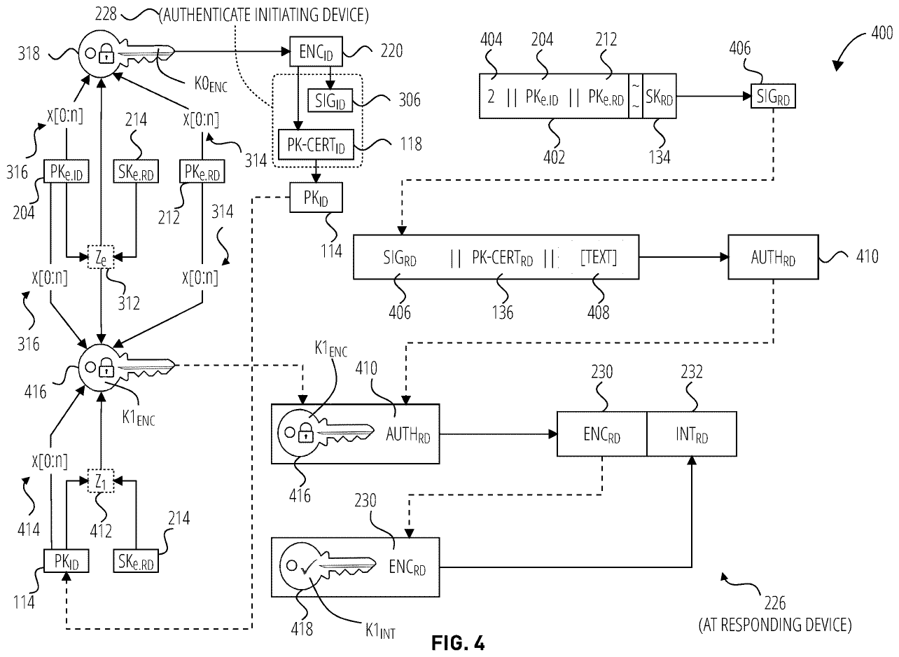

After receipt of the command 224, the responding device 104 performs what is referred to herein as an initiating-device-authentication and responding-device package-generation process 226, which is further discussed below in connection with FIG. 4. As described more fully below, the initiating-device-authentication and responding-device package-generation process 226 involves the responding device 104 authenticating the initiating device 102 (at an initiating-device authentication 228), and also involves the responding device 104 generating what are referred to in the present disclosure as a responding-device encrypted package 230 and a responding-device-encryption-package integrity data 232. The responding device 104 sends a response 234 to the initiating device 102, and the response 234 includes the responding-device encrypted package 230 and the responding-device-encryption-package integrity data 232. The contents of these data items in some embodiments are discussed below.

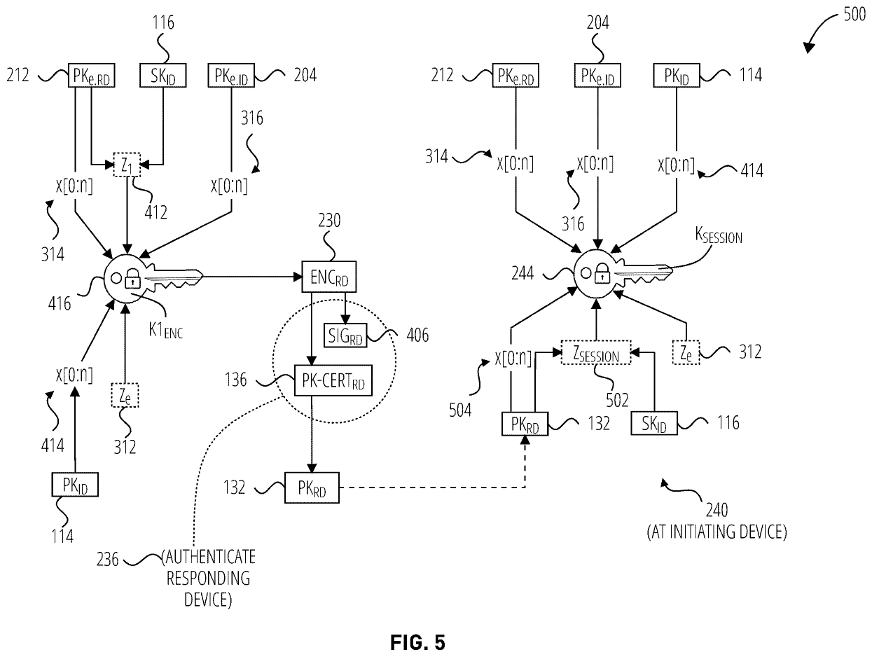

Furthermore, after receipt of the response 234 from the responding device 104, the initiating device 102 performs what is referred to in the present disclosure as a responding-device-authentication and initiating-device symmetric-session-key-generation process 240, which is further discussed below in connection with FIG. 5. As described more fully below, the responding-device-authentication and initiating-device symmetric-session-key-generation process 240 involves the initiating device 102 authenticating the responding device 104 (at a responding-device authentication 236), and also involves the initiating device 102 generating a symmetric session key 244. Once (i) the responding device 104 has performed the initiating-device authentication 228 and (ii) the initiating device 102 has performed the responding-device authentication 236, the initiating device 102 and the responding device 104 can be considered to be in a mutually-authenticated relationship 238, as indicated by the double-ended dashed arrow in FIG. 2.

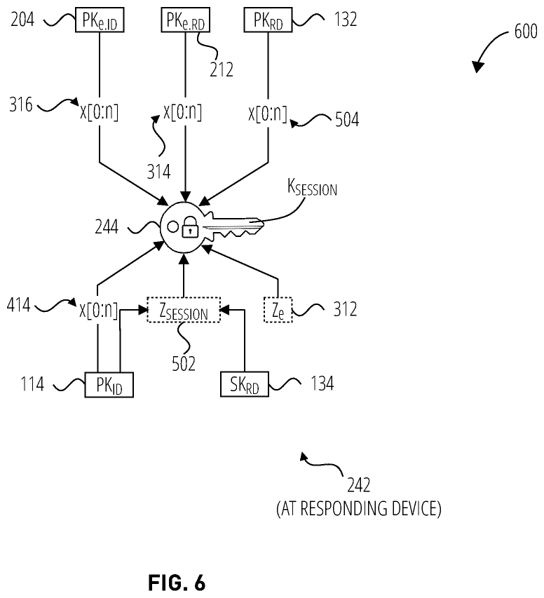

In some embodiments, the initiating device 102 and the responding device 104 thereafter engage in a secure communication session (e.g., a secure messaging session, as indicated by the secure-communication session 246). The initiating device 102 and the responding device 104 may engage in the secure-communication session 246 using the symmetric session key 244. As mentioned, the initiating device 102 generates the symmetric session key 244 as part of the responding-device-authentication and initiating-device symmetric-session-key-generation process 240. Moreover, the responding device 104 generates the same symmetric session key 244 as part of what is referred to in the present disclosure as a responding-device symmetric-session-key-generation process 242, which is described below in connection with FIG. 6. Example details of all of these processes are further discussed below.

Embodiments of the present disclosure accomplish mutual authentication using asymmetric encryption in ways that at least partially protect the privacy of one or both of the participants. As described below, the encryption and associated security increases at various stages of the herein-described embodiments. As described, the command 208 and the response 216 are both sent in plaintext, so neither of those two communications is protected by any security such as encryption. For this reason, in at least some embodiments, both the initiating device 102 and the responding device 104 validate the ephemeral public key received from the other device.

From there, the security of embodiments of the present disclosure increase across the successive communications and key derivations. Thus, the command 224 is more secure than either the command 208 or the response 216. Moreover, the response 234 is more secure than the command 224. Additionally, the secure-communication session 246 is more secure than the response 234. Embodiments of the present disclosure utilize ephemeral keys that are then discarded, enhancing the forward secrecy of the underlying communication exchanges.

As described more fully below, at each of the described stages (i.e., the command 224, the response 234, and the secure-communication session 246), a first symmetric encryption key is derived on both sides using all public keys (ephemeral and static) that have already been exchanged by the time that first symmetric key is being generated. Thus, both the initiating-device ephemeral public key 204 and the responding-device ephemeral public key 212 are used in deriving the first symmetric-encryption key that is used to encrypt (and then decrypt) the command 224. Further details are provided below.

Furthermore, the command 224 includes a copy of the initiating-device static public key 114 (in the reliable form of the signed initiating-device public-key certificate 118). As such, the response 234 is encrypted (and then decrypted) using a second symmetric key that is derived using not only the initiating-device ephemeral public key 204 and the responding-device ephemeral public key 212, but also the initiating-device static public key 114. Further details are provided below.

Lastly, the symmetric session key 244 is derived using all four public keys that are described herein: the initiating-device ephemeral public key 204, the initiating-device static public key 114, the responding-device ephemeral public key 212, and the responding-device static public key 132. It is noted that, in the response 234, the initiating device 102 obtains a reliable copy of the responding-device static public key 132 in the form of the signed responding-device public-key certificate 136.

Moreover, the secret and public keys used in the described Diffie-Hellman operations also progress from both being ephemeral in the case of the first symmetric key, to one being static and the other ephemeral in the case of the second symmetric key, and finally to both being static in the case of the symmetric session key 244. In the ensuing figures, the first symmetric key is referred to as the first symmetric key 318, and the second symmetric key is referred to as the second symmetric key 416.

Additionally, before proceeding to discussion of the ensuing figures, it is noted here that, in the described embodiments, the use of a given public key (or more than one public key) as an input (or inputs) into the key derivation function (KDF) of a given symmetric key does not involve using the entire public key, but instead using what is referred to in the present disclosure as a “context-binding identifier” of that public key. Such a context-binding identifier could be a substring of the actual public key, or perhaps be derived from all or part of the full public key, among other options. In the embodiments described below, each context-binding identifier is chosen to be the first eight (8) bytes of the “x” coordinate of the corresponding public key. This is by way of example, and certainly innumerable other approaches could be used. Furthermore, the term “public-key identifier” is used at times in the present disclosure as an equivalent to “context-binding identifier.”

Moreover, it is noted that the herein-described use of context-binding identifiers (a.k.a. public-key identifiers) as inputs into the respective KDFs of various symmetric keys is distinct from the (also-herein-described) use of asymmetric keys (both public and secret, and both ephemeral and static) as inputs into the calculation of shared secrets—e.g., as inputs into Diffie-Hellman operations used to calculate different respective shared secrets. In at least some embodiments, those shared secrets are then used together with some number of context-binding identifiers of public keys as inputs into the respective KDFs of various different symmetric keys, in order to derive the actual symmetric keys themselves. Additional inputs into KDFs could be used as well.

In the ensuing figures, a public-key identifier is represented with the text “x[0:n]” on a corresponding arrow on the corresponding figure, where the arrow extends from a representation of the entire public key to the particular symmetric key being generated. This text is meant to represent that these identifiers are formed of the first 8 bytes of the “x” coordinate of the given public key. In different conventions, the “n” could be a “7” to represent bytes 0-7, or could be an “8” to represent the byte-length of the identifier. And certainly other approaches and conventions could be used as well.

FIG. 3 depicts an example cryptography-architecture diagram 300, in accordance with at least one embodiment. The cryptography-architecture diagram 300 corresponds with the initiating-device package-generation process 218 of FIG. 2, and in at least one embodiment is performed by the initiating device 102.

The initiating-device package-generation process 218 begins with the initiating device 102 generating a value-sequence 302, which includes a concatenation of an integer 304, the initiating-device ephemeral public key 204, and the responding-device ephemeral public key 212. Moreover, the initiating device 102 cryptographically signs the value-sequence 302 using its initiating-device static secret key 116. The values and signature together are referred to in FIG. 3 as the initiating-device signature 306 (labeled “SIG_{ID}”), which is therefore a signature that is created “on the fly” in embodiments of the present disclosure. The integer 304 is shown with a value of “1” in FIG. 3, but could be a different value.

Next, the initiating device 102 concatenates the just-generated initiating-device signature 306, the initiating-device public-key certificate 118, and may also include an optional text field 308, though that could be omitted, left blank, or the like. This concatenated sequence of values is referred to in the present disclosure as the initiating-device authentication dataset 310.

The initiating device 102 conducts a Diffie-Hellman operation to calculate a first shared secret 312 (labeled “Zₑ”) from the responding-device ephemeral public key 212 and the initiating-device ephemeral secret key 206. Furthermore, the initiating device 102 generates the first symmetric key 318 based on the first shared secret 312 (“Zₑ”), an initiating-device-ephemeral-public-key identifier 316 of the initiating-device ephemeral public key 204, and a responding-device-ephemeral-public-key identifier 314 of the responding-device ephemeral public key 212. In this key derivation and others described herein, there could be additional inputs into the respective KDF as well.

Next, as described herein, the initiating device 102 encrypts the initiating-device authentication dataset 310 with the first symmetric key 318. The result of the encryption of the initiating-device authentication dataset 310 with the first symmetric key 318 is, in the depicted example, the initiating-device encrypted package 220 of FIG. 2. Moreover, although the associated KDF is not shown in FIG. 3, the initiating device 102 also generates a first data-integrity key 320, and uses the first data-integrity key 320 to create the initiating-device-encryption-package integrity data 222 of FIG. 2 as a data-integrity check on the initiating-device encrypted package 220.

FIG. 4 depicts an example cryptography-architecture diagram 400, in accordance with at least one embodiment. The cryptography-architecture diagram 400 corresponds with the initiating-device-authentication and responding-device package-generation process 226 of FIG. 2, and in at least one embodiment is performed by the responding device 104.

As described above, the initiating device 102 has transmitted the initiating-device encrypted package 220 to the responding device 104, and the initiating-device encrypted package 220 is encrypted with the first symmetric key 318. Thus, the responding device 104 then generates the same first symmetric key 318 in order to be able to decrypt the initiating-device encrypted package 220. As shown in FIG. 4, the responding device 104 first calculates the first shared secret 312 (“Zₑ”) with a Diffie-Hellman operation, though instead using the initiating-device ephemeral public key 204 and the responding-device ephemeral secret key 214. Next, the responding device 104 generates the first symmetric key 318 based on the same values as the initiating device 102: the first shared secret 312 (“Zₑ”), the initiating-device-ephemeral-public-key identifier 316 of the initiating-device ephemeral public key 204, and the responding-device-ephemeral-public-key identifier 314 of the responding-device ephemeral public key 212.

Next, the responding device 104 uses the first symmetric key 318 to decrypt the initiating-device encrypted package 220, to obtain therefrom the initiating-device signature 306 and the initiating-device public-key certificate 118. The responding device 104 uses those two data items to authenticate the initiating device 102—i.e., to perform the abovementioned initiating-device authentication 228. The responding device 104 does this in two steps. First, the responding device 104 verifies the trusted-authority signature of the initiating-device public-key certificate 118, to be able to trust that the initiating-device identity 120 that is listed in the initiating-device public-key certificate 118 does correspond to the initiating-device static public key 114 that is contained in the initiating-device public-key certificate 118. Second, the responding device 104 uses the initiating-device static public key 114 to verify that the initiating-device signature 306 was indeed signed using a static secret key (i.e., the initiating-device static secret key 116) that corresponds to the initiating-device static public key 114. Accordingly, the responding device 104 has now authenticated the initiating device 102.

Also as part of the initiating-device-authentication and responding-device package-generation process 226, the responding device 104 generates a value-sequence 402, which includes a concatenation of an integer 404, the initiating-device ephemeral public key 204, and the responding-device ephemeral public key 212. Moreover, the responding device 104 cryptographically signs the value-sequence 402 using its responding-device static secret key 134. The values and signature together are referred to in FIG. 4 as the responding-device signature 406 (labeled “SIG_{RD}”), which, like the initiating-device signature 306 of FIG. 3, is therefore also a signature that is created “on the fly” in embodiments of the present disclosure. The integer 404 is shown with a value of “2” in FIG. 4, but could be a different value, so long as the value of the integer 404 is different than the value of the integer 304.

Next, the responding device 104 concatenates the just-generated responding-device signature 406, the responding-device public-key certificate 136, and may also include an optional text field 408, though that could be omitted, left blank, or the like. This concatenated sequence of values is referred to in the present disclosure as the responding-device authentication dataset 410. The responding device 104 uses a second Diffie-Hellman operation to generate a second shared secret 412 (labeled “Z₁”) from the initiating-device static public key 114 and the responding-device ephemeral secret key 214. The responding device 104 then generates the second symmetric key 416 based on the first shared secret 312 (“Zₑ”), the second shared secret 412 (“Z₁”), the initiating-device-ephemeral-public-key identifier 316 of the initiating-device ephemeral public key 204, the responding-device-ephemeral-public-key identifier 314 of the responding-device ephemeral public key 212, and an initiating-device-static-public-key identifier 414 of the initiating-device static public key 114.

Next, as described herein, the responding device 104 encrypts the responding-device authentication dataset 410 with the second symmetric key 416. The result of the encryption of the responding-device authentication dataset 410 with the second symmetric key 416 is, in the depicted example, the responding-device encrypted package 230 of FIG. 2. Moreover, although the associated KDF is not shown in FIG. 4, the responding device 104 also generates a second data-integrity key 418, and uses the second data-integrity key 418 to create the responding-device-encryption-package integrity data 232 of FIG. 2 as a data-integrity check on the responding-device encrypted package 230.

FIG. 5 depicts an example cryptography-architecture diagram 500, in accordance with at least one embodiment. The cryptography-architecture diagram 500 corresponds with the responding-device-authentication and initiating-device symmetric-session-key-generation process 240 of FIG. 2, and in at least one embodiment is performed by the initiating device 102.

As described above, the responding device 104 has transmitted the responding-device encrypted package 230 to the initiating device 102, and the responding-device encrypted package 230 is encrypted with the second symmetric key 416. Thus, the initiating device 102 then generates the same second symmetric key 416 in order to be able to decrypt the responding-device encrypted package 230. As shown in FIG. 5, the initiating device 102 first calculates the second shared secret 412 (“Z₁”) with a Diffie-Hellman operation, though instead using the responding-device ephemeral public key 212 and the initiating-device static secret key 116. Next, the initiating device 102 generates the second symmetric key 416 based on the same values as the responding device 104: the first shared secret 312 (“Zₑ”), the second shared secret 412 (“Z₁”), the initiating-device-ephemeral-public-key identifier 316 of the initiating-device ephemeral public key 204, the responding-device-ephemeral-public-key identifier 314 of the responding-device ephemeral public key 212, and the initiating-device-static-public-key identifier 414 of the initiating-device static public key 114.

Next, the initiating device 102 uses the second symmetric key 416 to decrypt the responding-device encrypted package 230, to obtain therefrom the responding-device signature 406 and the responding-device public-key certificate 136. The initiating device 102 uses those two data items to authenticate the responding device 104—i.e., to perform the abovementioned responding-device authentication 236. The initiating device 102 does this in two steps. First, the initiating device 102 verifies the trusted-authority signature of the responding-device public-key certificate 136, to be able to trust that the responding-device identity 138 that is listed in the responding-device public-key certificate 136 does correspond to the responding-device static public key 132 that is contained in the responding-device public-key certificate 136. Second, the initiating device 102 uses the responding-device static public key 132 to verify that the responding-device signature 406 was indeed signed using a static secret key (i.e., the responding-device static secret key 134) that corresponds to the responding-device static public key 132. Accordingly, the initiating device 102 has now authenticated the responding device 104, and a mutual authentication (i.e., the mutually-authenticated relationship 238) has been established between the initiating device 102 and the responding device 104.

Also as part of the responding-device-authentication and initiating-device symmetric-session-key-generation process 240 that is depicted in FIG. 5, the initiating device 102 generates the abovementioned symmetric session key 244. The initiating device 102 conducts a Diffie-Hellman operation to generate a session shared secret 502 (labeled “Z_{SESSION}”) from the (recently received) responding-device static public key 132 and the initiating-device static secret key 116. The initiating device 102 then generates the symmetric session key 244 based on the first shared secret 312 (“Zₑ”), the session shared secret 502 (“Z_{SESSION}”), the initiating-device-ephemeral-public-key identifier 316 of the initiating-device ephemeral public key 204, the responding-device-ephemeral-public-key identifier 314 of the responding-device ephemeral public key 212, the initiating-device-static-public-key identifier 414 of the initiating-device static public key 114, and a responding-device-static-public-key identifier 504 of the responding-device static public key 132. As such, it can be seen that—context-binding identifiers of—all four public keys are used in the derivation of the symmetric session key 244. The ephemeral nature of two of those heightens the security provided by embodiments of the present disclosure.

FIG. 6 depicts an example cryptography-architecture diagram 600, in accordance with at least one embodiment. The cryptography-architecture diagram 600 corresponds with the responding-device symmetric-session-key-generation process 242 of FIG. 2, and in at least one embodiment is performed by the responding device 104.

In the responding-device symmetric-session-key-generation process 242, the responding device 104 generates the abovementioned symmetric session key 244. The responding device 104 conducts a Diffie-Hellman operation to generate the session shared secret 502 (“Z_{SESSION}”), though instead doing so from the initiating-device static public key 114 and the responding-device static secret key 134. The responding device 104 then generates the symmetric session key 244 using the same set of information that is used by the initiating device 102: the first shared secret 312 (“Zₑ”), the session shared secret 502 (“Z_{SESSION}”), the initiating-device-ephemeral-public-key identifier 316 of the initiating-device ephemeral public key 204, the responding-device-ephemeral-public-key identifier 314 of the responding-device ephemeral public key 212, the initiating-device-static-public-key identifier 414 of the initiating-device static public key 114, and the responding-device-static-public-key identifier 504 of the responding-device static public key 132. The initiating device 102 and the responding device 104 can both now participate in the secure-communication session 246 of FIG. 2 using the symmetric session key 244.

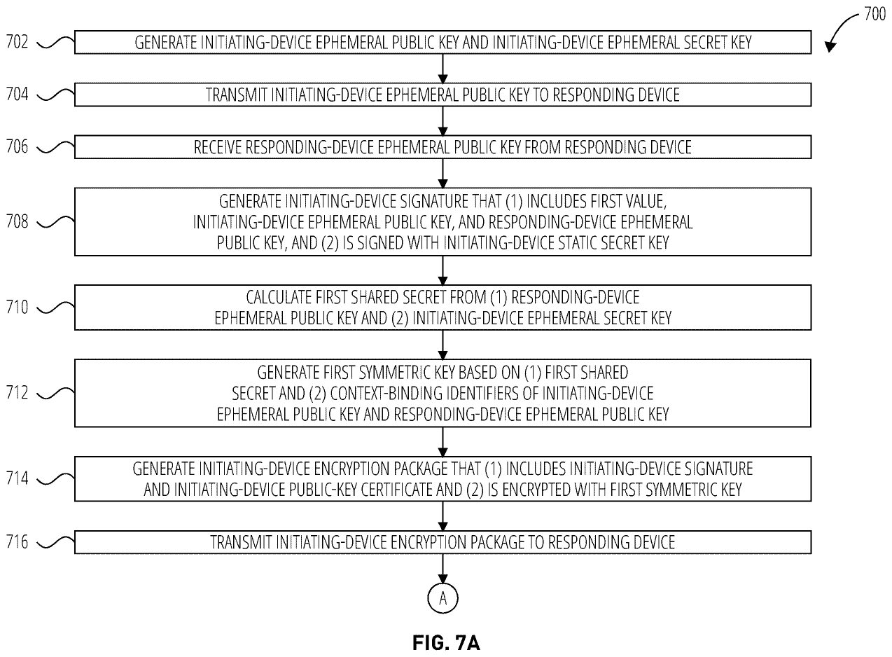

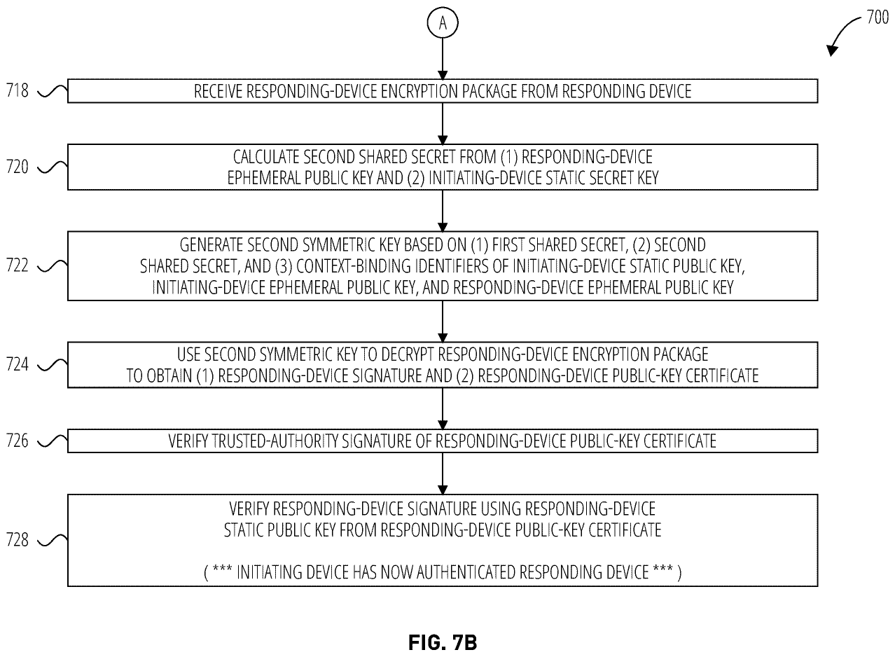

FIG. 7A and FIG. 7B together depict an example method 700, in accordance with at least one embodiment. The method 700 is described by way of example as being performed by the initiating device 102, though this is for illustration and not by way of limitation. The method 700 could be performed by any computing device or combination of devices that is suitably programmed to perform the described functions. For consistency with the descriptions of the preceding figures, the example method 700 is described below using elements from those figures, and as being performed by the initiating device 102.

At operation 702, the initiating device 102 generates an initiating-device ephemeral public key 204 and the corresponding initiating-device ephemeral secret key 206. At operation 704, the initiating device 102 transmits the initiating-device ephemeral public key 204 to the responding device 104. At operation 706, the initiating device 102 receives the responding-device ephemeral public key 212 from the responding device 104.

At operation 708, the initiating device 102 generates the initiating-device signature 306, which includes the integer 304, the initiating-device ephemeral public key 204, and the responding-device ephemeral public key 212, and which is cryptographically signed with the initiating-device static secret key 116. At operation 710, the initiating device 102 calculates the first shared secret 312 from the responding-device ephemeral public key 212 and the initiating-device ephemeral secret key 206. At operation 712, the initiating device 102 generates the first symmetric key 318 based on (i) the first shared secret 312 and (ii) context-binding identifiers of the initiating-device ephemeral public key 204 and the responding-device ephemeral public key 212. (In the descriptions of the method 700 and the below-described method 800, the public-key identifiers are not explicitly mentioned by reference number. They could be used, or not, but they are not explicitly mentioned here by reference number just for brevity.)

At operation 714, the initiating device 102 generates the initiating-device encrypted package 220, which includes the initiating-device signature 306 and the initiating-device public-key certificate 118. The initiating-device public-key certificate 118 includes the initiating-device static public key 114 and the first-trusted-authority cryptographic signature 124. The initiating-device encrypted package 220 is encrypted with the first symmetric key 318. At operation 716, the initiating device 102 transmits, to the responding device 104, the initiating-device encryption initiating-device encrypted package 220.

At operation 718, the initiating device 102 receives, from the responding device 104, responding-device encrypted package 230 encrypted with the second symmetric key 416. The responding-device encrypted package 230 includes the responding-device signature 406 and the responding-device public-key certificate 136. The responding-device signature 406 includes the integer 404, the initiating-device ephemeral public key 204, and the responding-device ephemeral public key 212. The responding-device signature 406 is cryptographically signed with the responding-device static secret key 134. The responding-device public-key certificate 136 includes the responding-device static public key 132 and the second-trusted-authority cryptographic signature 142.

At operation 720, the initiating device 102 calculates the second shared secret 412 from the responding-device ephemeral public key 212 and the initiating-device static secret key 116. At operation 722, the initiating device 102 generates the second symmetric key 416 based on (i) the first shared secret 312, (ii) the second shared secret 412, and (iii) context-binding identifiers of the initiating-device static public key 114, the initiating-device ephemeral public key 204, and the responding-device ephemeral public key 212. At operation 724, the initiating device 102 uses the second symmetric key 416 to decrypt the responding-device encrypted package 230 to obtain the responding-device signature 406 and the responding-device public-key certificate 136.

At operation 726 and operation 728, respectively, the initiating device 102 then authenticates the responding device 104 by (i) at operation 726, verifying the second-trusted-authority cryptographic signature 142 on the responding-device public-key certificate 136 with the second-trusted-authority public key 126; and (ii) at operation 728, verifying the responding-device signature 406 using the responding-device static public key 132 from the responding-device public-key certificate 136. The initiating device 102 has at that point authenticated the responding device 104.

In at least one embodiment, the initiating device 102 calculates the session shared secret 502 from the responding-device static public key 132 and the initiating-device static secret key 116. The initiating device 102 then generates the symmetric session key 244 based on (i) the first shared secret 312, (ii) the session shared secret 502, and (iii) context-binding identifiers of the initiating-device static public key 114, the initiating-device ephemeral public key 204, the responding-device static public key 132, and the responding-device ephemeral public key 212. The initiating device 102 may then engage in the secure-communication session 246 with the responding device 104 using the symmetric session key 244.

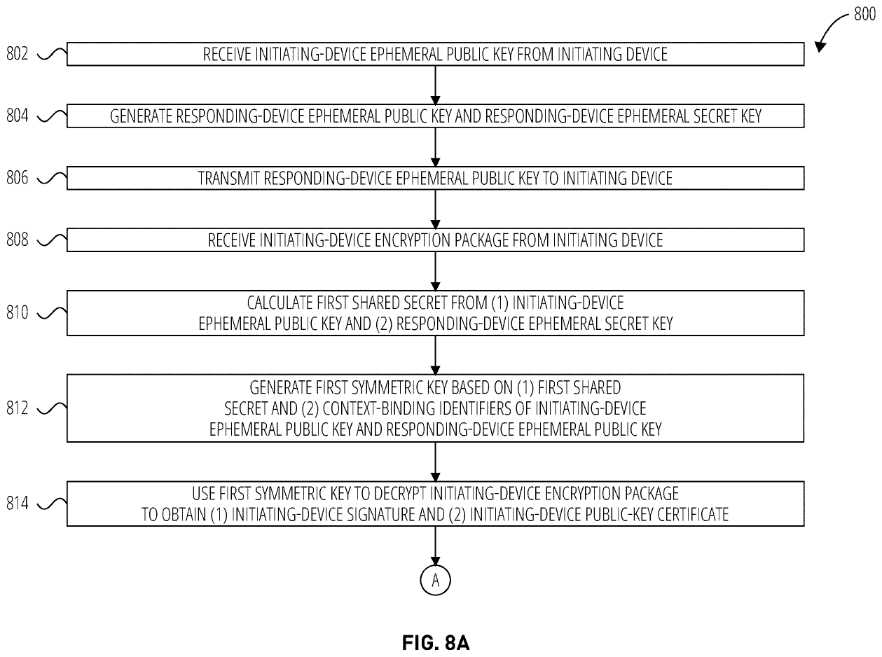

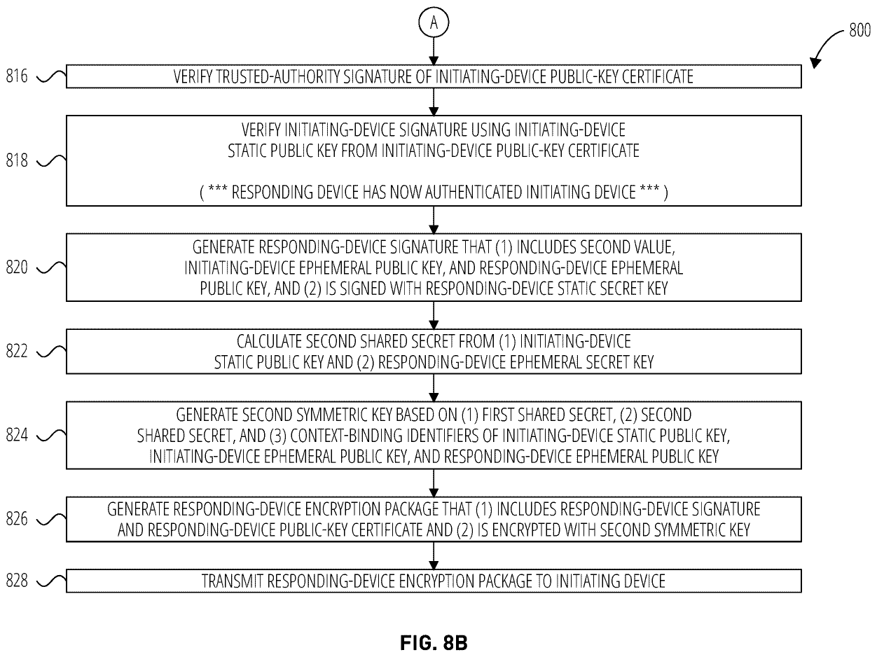

FIG. 8A and FIG. 8B together depict an example method 800, in accordance with at least one embodiment. The method 800 is described by way of example as being performed by the responding device 104, though this is for illustration and not by way of limitation. The method 800 could be performed by any computing device or combination of devices that is suitably programmed to perform the described functions. For consistency with the descriptions of the preceding figures, the example method 800 is described below using elements from those figures, and as being performed by the responding device 104.

At operation 802, the responding device 104 receives the initiating-device ephemeral public key 204 from the initiating device 102. At operation 804, the responding device 104 generates the responding-device ephemeral public key 212 and the responding-device ephemeral secret key 214. At operation 806, the responding device 104 transmits the responding-device ephemeral public key 212 to the initiating device 102. At operation 808, the responding device 104 receives, from the initiating device 102, the initiating-device encrypted package 220.

At operation 810, the responding device 104 calculates the first shared secret 312 from the initiating-device ephemeral public key 204 and the responding-device ephemeral secret key 214. At operation 812, the responding device 104 generates the first symmetric key 318 based on (i) the first shared secret 312 and (ii) context-binding identifiers of the initiating-device ephemeral public key 204 and the responding-device ephemeral public key 212. At operation 814, the responding device 104 uses the first symmetric key 318 to decrypt the initiating-device encrypted package 220 to obtain the initiating-device signature 306 and the initiating-device public-key certificate 118.

At operation 816 and operation 818, respectively, the responding device 104 authenticates the initiating device 102 by (i) at operation 816, verifying the first-trusted-authority cryptographic signature 124 on the initiating-device public-key certificate 118 with the first-trusted-authority public key 144 and (ii) at operation 818, verifying the initiating-device signature 306 using the initiating-device static public key 114 from the initiating-device public-key certificate 118.

At operation 820, the responding device 104 generates the responding-device signature 406, which includes the integer 404, the initiating-device ephemeral public key 204, and the responding-device ephemeral public key 212. At operation 822, the responding device 104 calculates the second shared secret 412 from the initiating-device static public key 114 and the responding-device ephemeral secret key 214. At operation 824, the responding device 104 generates the second symmetric key 416 based on (i) the first shared secret 312, (ii) the second shared secret 412, and (iii) context-binding identifiers of the initiating-device static public key 114, the initiating-device ephemeral public key 204, and the responding-device ephemeral public key 212.

At operation 826, the responding device 104 generates the responding-device encrypted package 230, including encrypting the responding-device encrypted package 230 with the second symmetric key 416. At operation 828, the responding device 104 transmits the responding-device encrypted package 230 to the initiating device 102.

In at least one embodiment, the responding device 104 calculates the session shared secret 502 from the initiating-device static public key 114 and the responding-device static secret key 134. The responding device 104 generates the symmetric session key 244 based on (i) the first shared secret 312, (ii) the session shared secret 502, and (iii) context-binding identifiers of the initiating-device ephemeral public key 204, the initiating-device static public key 114, the responding-device ephemeral public key 212, and the responding-device static public key 132. The responding device 104 may then engage in the secure-communication session 246 with the initiating device 102 using the symmetric session key 244.

FIG. 9 depicts an example computer system 900 that could be utilized to embody and/or perform at least one embodiment, and within which instructions 912 (e.g., software, a program, an application, an applet, an app, and/or other executable code) may be executed to cause the computer system 900 to perform any one or more of the methodologies discussed herein. For example, execution of the instructions 912 may cause the computer system 900 to perform any one or more of the methods described herein. The instructions 912 transform the general, non-programmed computer system 900 into a particular computer system 900 programmed to carry out the described and illustrated functions in the manner described. The computer system 900 may operate as a standalone device or may be coupled (e.g., networked) to other machines. In a networked deployment, the computer system 900 may operate in the capacity of a server machine or a client machine in a server-client network environment, or as a peer machine in a peer-to-peer (or distributed) network environment.

The computer system 900 may be or include, but is limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, and/or any other machine capable of executing the instructions 912, sequentially or otherwise, that specify actions to be taken by the computer system 900. Further, while only a single computer system 900 is illustrated, the term “machine” shall also be taken to include a collection of machines that individually or jointly execute the instructions 912 to perform any one or more of the methodologies discussed herein.

The computer system 900 may include processors 902, memory 904, and I/O components 906, which may be configured to communicate with each other via a bus 944. In an example embodiment, the processors 902 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, and/or any suitable combination thereof) may include, for example, a processor 908 and a processor 910 that execute the instructions 912. The term “processor” is intended to include multi-core processors that may include two or more independent processors (sometimes referred to as “cores”) that may execute instructions contemporaneously. Although FIG. 9 shows multiple processors 902, the computer system 900 may include a single processor with a single core, a single processor with multiple cores (e.g., a multi-core processor), multiple processors with a single core, multiple processors with multiples cores, or any combination thereof.

The memory 904 includes a main memory 914, a static memory 916, and a storage unit 918, each of which is accessible to the processors 902 via the bus 944. The memory 904, the static memory 916, and/or the storage unit 918 may store the instructions 912 executable for performing any one or more of the methodologies or functions described herein. The instructions 912 may also or instead reside completely or partially within the main memory 914, within the static memory 916, within machine-readable medium 920 within the storage unit 918, within at least one of the processors 902 (e.g., within a cache memory of a given one of the processors 902), and/or any suitable combination thereof, during execution thereof by the computer system 900. The machine-readable medium 920 is one or more non-transitory computer-readable storage media.

The I/O components 906 may include a wide variety of components to receive input, produce and/or provide output, transmit information, exchange information, capture measurements, and/or the like. The specific I/O components 906 that are included in a particular instance of the computer system 900 will depend on the type of machine. For example, portable machines such as mobile phones may include a touch input device or other such input mechanisms, while a headless server machine may not include such a touch input device. It will be appreciated that the I/O components 906 may include many other components that are not shown in FIG. 9.

In various example embodiments, the I/O components 906 may include output components 932 and input components 930. The output components 932 may include visual components (e.g., a display such as a plasma display panel (PDP), a light emitting diode (LED) display, a liquid crystal display (LCD), a projector, and/or a cathode ray tube (CRT)), acoustic components (e.g., speakers), haptic components (e.g., a vibratory motor, resistance mechanisms), other signal generators, and so forth. The input components 930 may include alphanumeric input components (e.g., a keyboard, a touchscreen configured to receive alphanumeric input, a photo-optical keyboard, and/or other alphanumeric input components), point-based input components (e.g., a mouse, a touchpad, a trackball, a joystick, a motion sensor, and/or one or more other pointing instruments), tactile input components (e.g., a physical button, a touchscreen that is responsive to location and/or force of touches or touch gestures, and/or one or more other tactile input components), audio input components (e.g., a microphone), and/or the like.

In further example embodiments, the I/O components 906 may include biometric components 934, motion components 936, environmental components 938, and/or position components 940, among a wide array of other components. The biometric components 934 may include components to detect expressions (e.g., hand expressions, facial expressions, vocal expressions, body gestures, eye tracking, and/or the like), measure biosignals (e.g., blood pressure, heart rate, body temperature, perspiration, brain waves, and/or the like), identify a person (by way of, e.g., voice identification, retinal identification, facial identification, fingerprint identification, and/or electroencephalogram-based identification), and/or the like. The motion components 936 may include acceleration-sensing components (e.g., an accelerometer), gravitation-sensing components, rotation-sensing components (e.g., a gyroscope), etc.

The environmental components 938 may include, for example, illumination-sensing components (e.g., a photometer), temperature-sensing components (e.g., one or more thermometers), humidity-sensing components, pressure-sensing components (e.g., a barometer), acoustic-sensing components (e.g., one or more microphones), proximity-sensing components (e.g., infrared sensors that detect nearby objects), gas-sensing components (e.g., gas-detection sensors to detection concentrations of hazardous gases for safety and/or to measure pollutants in the atmosphere), and/or other components that may provide indications, measurements, signals, and/or the like that correspond to a surrounding physical environment. The position components 940 may include location-sensing components (e.g., a global positioning system (GPS) receiver), altitude-sensing components (e.g., altimeters and/or barometers that detect air pressure from which altitude may be derived), orientation-sensing components (e.g., magnetometers), and/or the like.

Communication may be implemented using a wide variety of technologies. The I/O components 906 may further include communication components 942 operable to communicatively couple the computer system 900 to a network 922 and/or devices 924 via a coupling 926 and/or a coupling 928, respectively. For example, the communication components 942 may include a network-interface component or another suitable device to interface with the network 922. In further examples, the communication components 942 may include wired-communication components, wireless-communication components, cellular-communication components, Near Field Communication (NFC) components, Bluetooth (e.g., Bluetooth Low Energy) components, Wi-Fi components, and/or other communication components to provide communication via one or more other modalities. The devices 924 may include one or more other machines and/or any of a wide variety of peripheral devices (e.g., a peripheral device coupled via a universal serial bus (USB) connection).

Moreover, the communication components 942 may detect identifiers or include components operable to detect identifiers. For example, the communication components 942 may include radio frequency identification (RFID) tag reader components, NFC-smart-tag detection components, optical-reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and/or other optical codes), and/or acoustic-detection components (e.g., microphones to identify tagged audio signals). In addition, a variety of information may be derived via the communication components 942, such as location via Internet Protocol (IP) geolocation, location via Wi-Fi signal triangulation, location via detecting an NFC beacon signal that may indicate a particular location, and/or the like.

One or more of the various memories (e.g., the memory 904, the main memory 914, the static memory 916, and/or the (e.g., cache) memory of one or more of the processors 902) and/or the storage unit 918 may store one or more sets of instructions (e.g., software) and/or data structures embodying or used by any one or more of the methodologies or functions described herein. These instructions (e.g., the instructions 912), when executed by one or more of the processors 902, cause various operations to implement various embodiments of the present disclosure.

The instructions 912 may be transmitted or received over the network 922, using a transmission medium, via a network-interface device (e.g., a network-interface component included in the communication components 942) and using any one of a number of well-known transfer protocols (e.g., the Session Initiation Protocol (SIP), the hypertext transfer protocol (HTTP), and/or the like). Similarly, the instructions 912 may be transmitted or received using a transmission medium via the coupling 928 (e.g., a peer-to-peer coupling) to the devices 924.

FIG. 10 depicts an example software architecture 1002 that could be executed on the example computer system 900 of FIG. 9, in accordance with at least one embodiment. The illustrated example software architecture 1002 can be installed on any one or more of the devices described herein. For example, the software architecture 1002 could be installed on any device or system that is arranged similar to the computer system 900 of FIG. 9. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such an operating system 1012, libraries 1014, frameworks 1016, and applications 1018. Operationally, using one or more application programming interfaces (APIs), the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 may provide memory management, processor management (e.g., scheduling), component management, networking, and/or security settings, in some cases among other functionality. The services 1026 can provide other common services for the other software layers. The drivers 1028 are responsible for controlling or interfacing with the underlying hardware. For instance, the drivers 1028 can include display drivers, camera drivers, Bluetooth or Bluetooth Low Energy drivers, flash memory drivers, serial communication drivers (e.g., USB drivers), Wi-Fi drivers, audio drivers, power management drivers, and/or the like.

The libraries 1014 provide a low-level common infrastructure used by the applications 1018. The libraries 1014 can include system libraries 1030 (e.g., a C standard library) that provide functions such as memory-allocation functions, string-manipulation functions, mathematic functions, and/or the like. In addition, the libraries 1014 can include API libraries 1032 such as media libraries (e.g., libraries to support presentation and/or manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG), and/or the like), graphics libraries (e.g., an OpenGL framework used to render in two dimensions (2D) and three dimensions (3D) in graphic content on a display), database libraries (e.g., SQLite to provide various relational-database functions), web libraries (e.g., WebKit to provide web-browsing functionality), and/or the like. The libraries 1014 can also include a wide variety of other libraries 1034 to provide many other APIs to the applications 1018.

The frameworks 1016 may provide a high-level common infrastructure that is used by the applications 1018. For example, the frameworks 1016 may provide various graphical user interface (GUI) functions, high-level resource management, high-level location services, and/or the like. The frameworks 1016 can provide a broad spectrum of other APIs that can be used by the applications 1018, some of which may be specific to a particular operating system or platform.

Purely as representative examples, the applications 1018 may include a home application 1036, a contacts application 1038, a browser application 1040, a book-reader application 1042, a location application 1044, a media application 1046, a messaging application 1048, a game application 1050, and/or a broad assortment of other applications generically represented in FIG. 10 as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, C++, etc.), procedural programming languages (e.g., C, assembly language, etc.), and/or the like. In a specific example, the third-party application 1052 (e.g., an application developed using the ANDROID™ or IOS™ software development kit (SDK) by an entity other than the vendor of the particular platform) could be mobile software running on a mobile operating system such as IOS™, ANDROID™, WINDOWS® Phone, and/or the like. In this example, the third-party application 1052 can invoke the API calls 1020 provided by the operating system 1012 to facilitate functionality described herein.

In view of the disclosure above, a listing of various examples of embodiments is set forth below. It should be noted that one or more features of an example, taken in isolation or combination, should be considered to be within the disclosure of this application.

Example 1 is a method performed by executing instructions on at least one hardware processor, the method including, at an initiating device: sending, to a responding device, an initiating-device ephemeral public key having a corresponding initiating-device ephemeral secret key at the initiating device, the initiating device further including an initiating-device static secret key and a corresponding initiating-device static public key; receiving, from the responding device, a responding-device ephemeral public key having a corresponding responding-device ephemeral secret key at the responding device, the responding device further including a responding-device static secret key and a corresponding responding-device static public key; generating an initiating-device signature that includes a first value, the initiating-device ephemeral public key, and the responding-device ephemeral public key, the initiating-device signature being cryptographically signed with the initiating-device static secret key; calculating a first shared secret from the responding-device ephemeral public key and the initiating-device ephemeral secret key; generating a first symmetric key based on (i) the first shared secret and (ii) context-binding identifiers of the initiating-device ephemeral public key and the responding-device ephemeral public key; generating an initiating-device encryption package including the initiating-device signature and an initiating-device public-key certificate, the initiating-device public-key certificate including the initiating-device static public key and a cryptographic signature of a first trusted authority, the initiating-device encryption package being encrypted with the first symmetric key; and transmitting, to the responding device, the initiating-device encryption package.

Example 2 is the method of Example 1, further including, at the initiating device: receiving, from the responding device, a responding-device encryption package encrypted with a second symmetric key, the responding-device encryption package including a responding-device signature and a responding-device public-key certificate, the responding-device signature including a second value, the initiating-device ephemeral public key, and the responding-device ephemeral public key, the responding-device signature being cryptographically signed with the responding-device static secret key, the responding-device public-key certificate including the responding-device static public key and a cryptographic signature of a second trusted authority; calculating a second shared secret from the responding-device ephemeral public key and the initiating-device static secret key; generating the second symmetric key based on (i) the first shared secret, (ii) the second shared secret, and (iii) context-binding identifiers of the initiating-device static public key, the initiating-device ephemeral public key, and the responding-device ephemeral public key; using the second symmetric key to decrypt the responding-device encryption package to obtain the responding-device signature and the responding-device public-key certificate; and authenticating the responding device by: verifying the cryptographic signature of the second trusted authority on the responding-device public-key certificate with a public key of the second trusted authority; and verifying the responding-device signature using the responding-device static public key from the responding-device public-key certificate.

Example 3 is the method of Example 2, further including, at the responding device: receiving, from the initiating device, the initiating-device encryption package; calculating the first shared secret from the initiating-device ephemeral public key and the responding-device ephemeral secret key; generating the first symmetric key based on (i) the first shared secret and (ii) context-binding identifiers of the initiating-device ephemeral public key and the responding-device ephemeral public key; using the first symmetric key to decrypt the initiating-device encryption package to obtain the initiating-device signature and the initiating-device public-key certificate; and authenticating the initiating device by: verifying the cryptographic signature of the first trusted authority on the initiating-device public-key certificate with a public key of the first trusted authority; and verifying the initiating-device signature using the initiating-device static public key from the initiating-device public-key certificate.

Example 4 is the method of Example 3, further including, at the responding device: generating the responding-device signature; calculating the second shared secret from the initiating-device static public key and the responding-device ephemeral secret key; generating the second symmetric key based on (i) the first shared secret, (ii) the second shared secret, and (iii) context-binding identifiers of the initiating-device static public key, the initiating-device ephemeral public key, and the responding-device ephemeral public key; generating the responding-device encryption package, including encrypting the responding-device encryption package with the second symmetric key; and transmitting the responding-device encryption package to the initiating device.

Example 5 is the method of Example 4, further including, at the initiating device: calculating a session shared secret from the responding-device static public key and the initiating-device static secret key; generating a symmetric session key based on (i) the first shared secret, (ii) the session shared secret, and (iii) context-binding identifiers of the initiating-device static public key, the initiating-device ephemeral public key, the responding-device static public key, and the responding-device ephemeral public key; and engaging in a secure communication session with the responding device using the symmetric session key.

Example 6 is the method of Example 5, further including, at the responding device: calculating the session shared secret from the initiating-device static public key and the responding-device static secret key; generating the symmetric session key based on (i) the first shared secret, (ii) the session shared secret, and (iii) context-binding identifiers of the initiating-device ephemeral public key, the initiating-device static public key, the responding-device ephemeral public key, and the responding-device static public key; and engaging in the secure communication session with the initiating device using the symmetric session key.

Example 7 is the method of Example 6, where a context-binding identifier of a public key is a predetermined substring of the public key.

Example 8 is the method of Example 7, where the predetermined substring of the public key is a predetermined substring of a coordinate of the public key.

Example 9 is the method of any of the Examples 6-8, where: the initiating device includes a card reader for an access-control system; and the responding device includes an access card for the access-control system.

Example 10 is the method of any of the Examples 6-8, where: the initiating device is implemented on a first mobile device; and the responding device is implemented on a second mobile device.

Example 11 is a system including: at least one hardware processor; and one or more non-transitory computer readable storage media containing instructions that, when executed by the at least one hardware processor, cause the system to perform operations including, at an initiating device: sending, to a responding device, an initiating-device ephemeral public key having a corresponding initiating-device ephemeral secret key at the initiating device, the initiating device further including an initiating-device static secret key and a corresponding initiating-device static public key; receiving, from the responding device, a responding-device ephemeral public key having a corresponding responding-device ephemeral secret key at the responding device, the responding device further including a responding-device static secret key and a corresponding responding-device static public key; generating an initiating-device signature that includes a first value, the initiating-device ephemeral public key, and the responding-device ephemeral public key, the initiating-device signature being cryptographically signed with the initiating-device static secret key; calculating a first shared secret from the responding-device ephemeral public key and the initiating-device ephemeral secret key; generating a first symmetric key based on (i) the first shared secret and (ii) context-binding identifiers of the initiating-device ephemeral public key and the responding-device ephemeral public key; generating an initiating-device encryption package including the initiating-device signature and an initiating-device public-key certificate, the initiating-device public-key certificate including the initiating-device static public key and a cryptographic signature of a first trusted authority, the initiating-device encryption package being encrypted with the first symmetric key; and transmitting, to the responding device, the initiating-device encryption package.

Example 12 is the system of Example 11, the operations further including, at the initiating device: receiving, from the responding device, a responding-device encryption package encrypted with a second symmetric key, the responding-device encryption package including a responding-device signature and a responding-device public-key certificate, the responding-device signature including a second value, the initiating-device ephemeral public key, and the responding-device ephemeral public key, the responding-device signature being cryptographically signed with the responding-device static secret key, the responding-device public-key certificate including the responding-device static public key and a cryptographic signature of a second trusted authority; calculating a second shared secret from the responding-device ephemeral public key and the initiating-device static secret key; generating the second symmetric key based on (i) the first shared secret, (ii) the second shared secret, and (iii) context-binding identifiers of the initiating-device static public key, the initiating-device ephemeral public key, and the responding-device ephemeral public key; using the second symmetric key to decrypt the responding-device encryption package to obtain the responding-device signature and the responding-device public-key certificate; and authenticating the responding device by: verifying the cryptographic signature of the second trusted authority on the responding-device public-key certificate with a public key of the second trusted authority; and verifying the responding-device signature using the responding-device static public key from the responding-device public-key certificate.

Example 13 is the system of Example 12, the operations further including, at the responding device: receiving, from the initiating device, the initiating-device encryption package; calculating the first shared secret from the initiating-device ephemeral public key and the responding-device ephemeral secret key; generating the first symmetric key based on (i) the first shared secret and (ii) context-binding identifiers of the initiating-device ephemeral public key and the responding-device ephemeral public key; using the first symmetric key to decrypt the initiating-device encryption package to obtain the initiating-device signature and the initiating-device public-key certificate; and authenticating the initiating device by: verifying the cryptographic signature of the first trusted authority on the initiating-device public-key certificate with a public key of the first trusted authority; and verifying the initiating-device signature using the initiating-device static public key from the initiating-device public-key certificate.

Example 14 is the system of Example 13, the operations further including, at the responding device: generating the responding-device signature; calculating the second shared secret from the initiating-device static public key and the responding-device ephemeral secret key; generating the second symmetric key based on (i) the first shared secret, (ii) the second shared secret, and (iii) context-binding identifiers of the initiating-device static public key, the initiating-device ephemeral public key, and the responding-device ephemeral public key; generating the responding-device encryption package, including encrypting the responding-device encryption package with the second symmetric key; and transmitting the responding-device encryption package to the initiating device.

Example 15 is the system of Example 14, the operations further including, at the initiating device: calculating a session shared secret from the responding-device static public key and the initiating-device static secret key; generating a symmetric session key based on (i) the first shared secret, (ii) the session shared secret, and (iii) context-binding identifiers of the initiating-device static public key, the initiating-device ephemeral public key, the responding-device static public key, and the responding-device ephemeral public key; and engaging in a secure communication session with the responding device using the symmetric session key.

Example 16 is the system of Example 15, the operations further including, at the responding device: calculating the session shared secret from the initiating-device static public key and the responding-device static secret key; generating the symmetric session key based on (i) the first shared secret, (ii) the session shared secret, and (iii) context-binding identifiers of the initiating-device ephemeral public key, the initiating-device static public key, the responding-device ephemeral public key, and the responding-device static public key; and engaging in the secure communication session with the initiating device using the symmetric session key.

Example 17 is the system of Example 16, where a context-binding identifier of a public key is a predetermined substring of the public key.

Example 18 is the system of Example 17, where the predetermined substring of the public key is a predetermined substring of a coordinate of the public key.

Example 19 is the system of any of the Examples 16-18, where: the initiating device includes a card reader for an access-control system; and the responding device includes an access card for the access-control system.

Example 20 is the system of any of the Examples 16-18, where: the initiating device is implemented on a first mobile device; and the responding device is implemented on a second mobile device.

Example 21 is one or more non-transitory computer readable storage media containing instructions that, when executed by at least one hardware processor of a first computing device, cause the first computing device to perform operations including: sending, to a responding device, an initiating-device ephemeral public key having a corresponding initiating-device ephemeral secret key at the initiating device, the initiating device further including an initiating-device static secret key and a corresponding initiating-device static public key; receiving, from the responding device, a responding-device ephemeral public key having a corresponding responding-device ephemeral secret key at the responding device, the responding device further including a responding-device static secret key and a corresponding responding-device static public key; generating an initiating-device signature that includes a first value, the initiating-device ephemeral public key, and the responding-device ephemeral public key, the initiating-device signature being cryptographically signed with the initiating-device static secret key; calculating a first shared secret from the responding-device ephemeral public key and the initiating-device ephemeral secret key; generating a first symmetric key based on (i) the first shared secret and (ii) context-binding identifiers of the initiating-device ephemeral public key and the responding-device ephemeral public key; generating an initiating-device encryption package including the initiating-device signature and an initiating-device public-key certificate, the initiating-device public-key certificate including the initiating-device static public key and a cryptographic signature of a first trusted authority, the initiating-device encryption package being encrypted with the first symmetric key; and transmitting, to the responding device, the initiating-device encryption package.

Example 22 is the one or more non-transitory computer readable storage media of Example 21, the operations further including, at the initiating device: receiving, from the responding device, a responding-device encryption package encrypted with a second symmetric key, the responding-device encryption package including a responding-device signature and a responding-device public-key certificate, the responding-device signature including a second value, the initiating-device ephemeral public key, and the responding-device ephemeral public key, the responding-device signature being cryptographically signed with the responding-device static secret key, the responding-device public-key certificate including the responding-device static public key and a cryptographic signature of a second trusted authority; calculating a second shared secret from the responding-device ephemeral public key and the initiating-device static secret key; generating the second symmetric key based on (i) the first shared secret, (ii) the second shared secret, and (iii) context-binding identifiers of the initiating-device static public key, the initiating-device ephemeral public key, and the responding-device ephemeral public key; using the second symmetric key to decrypt the responding-device encryption package to obtain the responding-device signature and the responding-device public-key certificate; and authenticating the responding device by: verifying the cryptographic signature of the second trusted authority on the responding-device public-key certificate with a public key of the second trusted authority; and verifying the responding-device signature using the responding-device static public key from the responding-device public-key certificate.

Example 23 is the one or more non-transitory computer readable storage media of Example 22, the operations further including, at the responding device: receiving, from the initiating device, the initiating-device encryption package; calculating the first shared secret from the initiating-device ephemeral public key and the responding-device ephemeral secret key; generating the first symmetric key based on (i) the first shared secret and (ii) context-binding identifiers of the initiating-device ephemeral public key and the responding-device ephemeral public key; using the first symmetric key to decrypt the initiating-device encryption package to obtain the initiating-device signature and the initiating-device public-key certificate; authenticating the initiating device by: verifying the cryptographic signature of the first trusted authority on the initiating-device public-key certificate with a public key of the first trusted authority; and verifying the initiating-device signature using the initiating-device static public key from the initiating-device public-key certificate.

Example 24 is the one or more non-transitory computer readable storage media of Example 23, the operations further including, at the responding device: generating the responding-device signature; calculating the second shared secret from the initiating-device static public key and the responding-device ephemeral secret key; generating the second symmetric key based on (i) the first shared secret, (ii) the second shared secret, and (iii) context-binding identifiers of the initiating-device static public key, the initiating-device ephemeral public key, and the responding-device ephemeral public key; generating the responding-device encryption package, including encrypting the responding-device encryption package with the second symmetric key; and transmitting the responding-device encryption package to the initiating device.

Example 25 is the one or more non-transitory computer readable storage media of Example 24, the operations further including: at the initiating device: calculating a session shared secret from the responding-device static public key and the initiating-device static secret key; generating a symmetric session key based on (i) the first shared secret, (ii) the session shared secret, and (iii) context-binding identifiers of the initiating-device static public key, the initiating-device ephemeral public key, the responding-device static public key, and the responding-device ephemeral public key; and engaging in a secure communication session with the responding device using the symmetric session key; and at the responding device: calculating the session shared secret from the initiating-device static public key and the responding-device static secret key; generating the symmetric session key based on (i) the first shared secret, (ii) the session shared secret, and (iii) context-binding identifiers of the initiating-device ephemeral public key, the initiating-device static public key, the responding-device ephemeral public key, and the responding-device static public key; and engaging in the secure communication session with the initiating device using the symmetric session key.

Furthermore, in this disclosure, in one or more embodiments, examples, and/or the like, it may be the case that one or more components of one or more devices, systems, and/or the like are referred to as modules that carry out (e.g., perform, execute, and the like) various functions. With respect to any such usages in the present disclosure, a module includes both hardware and instructions. The hardware could include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more devices and/or components of any other type deemed suitable by those of skill in the art for a given implementation.

In at least one embodiment, the instructions for a given module are executable by the hardware for carrying out the one or more herein-described functions of the module, and could include hardware (e.g., hardwired) instructions, firmware instructions, software instructions, and/or the like, stored in any one or more non-transitory computer-readable storage media deemed suitable by those of skill in the art for a given implementation. Each such non-transitory computer-readable storage medium could be or include memory (e.g., random access memory (RAM), read-only memory (ROM), erasable programmable read-only memory (EPROM), electrically erasable programmable read-only memory (EEPROM a.k.a. E2PROM), flash memory, and/or one or more other types of memory) and/or one or more other types of non-transitory computer-readable storage medium. A module could be realized as a single component or be distributed across multiple components. In some cases, a module may be referred to as a unit.

Moreover, consistent with the fact that the entities and arrangements that are described herein, including the entities and arrangements that are depicted in and described in connection with the drawings, are presented as examples and not by way of limitation, any and all statements or other indications as to what a particular drawing “depicts,” what a particular element or entity in a particular drawing or otherwise mentioned in this disclosure “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively qualified by such a clause. It is for reasons akin to brevity and clarity of presentation that this implied qualifying clause is not repeated ad nauseum in this disclosure.

1. A method performed by executing instructions on at least one hardware processor, the method comprising, at an initiating device:
sending, to a responding device, an initiating-device ephemeral public key having a corresponding initiating-device ephemeral secret key at the initiating device, the initiating device further comprising an initiating-device static secret key and a corresponding initiating-device static public key;
receiving, from the responding device, a responding-device ephemeral public key having a corresponding responding-device ephemeral secret key at the responding device, the responding device further comprising a responding-device static secret key and a corresponding responding-device static public key;
generating an initiating-device signature that comprises a first value, the initiating-device ephemeral public key, and the responding-device ephemeral public key, the initiating-device signature being cryptographically signed with the initiating-device static secret key;
calculating a first shared secret from the responding-device ephemeral public key and the initiating-device ephemeral secret key;
generating a first symmetric key based on (i) the first shared secret and (ii) context-binding identifiers of the initiating-device ephemeral public key and the responding-device ephemeral public key;
generating an initiating-device encryption package comprising the initiating-device signature and an initiating-device public-key certificate, the initiating-device public-key certificate comprising the initiating-device static public key and a cryptographic signature of a first trusted authority, the initiating-device encryption package being encrypted with the first symmetric key; and
transmitting, to the responding device, the initiating-device encryption package.

2. The method of claim 1, further comprising, at the initiating device:
receiving, from the responding device, a responding-device encryption package encrypted with a second symmetric key, the responding-device encryption package comprising a responding-device signature and a responding-device public-key certificate, the responding-device signature comprising a second value, the initiating-device ephemeral public key, and the responding-device ephemeral public key, the responding-device signature being cryptographically signed with the responding-device static secret key, the responding-device public-key certificate comprising the responding-device static public key and a cryptographic signature of a second trusted authority;
calculating a second shared secret from the responding-device ephemeral public key and the initiating-device static secret key;
generating the second symmetric key based on (i) the first shared secret, (ii) the second shared secret, and (iii) context-binding identifiers of the initiating-device static public key, the initiating-device ephemeral public key, and the responding-device ephemeral public key;
using the second symmetric key to decrypt the responding-device encryption package to obtain the responding-device signature and the responding-device public-key certificate; and
authenticating the responding device by:
verifying the cryptographic signature of the second trusted authority on the responding-device public-key certificate with a public key of the second trusted authority; and
verifying the responding-device signature using the responding-device static public key from the responding-device public-key certificate.

3. The method of claim 2, further comprising, at the responding device:
receiving, from the initiating device, the initiating-device encryption package;
calculating the first shared secret from the initiating-device ephemeral public key and the responding-device ephemeral secret key;
generating the first symmetric key based on (i) the first shared secret and (ii) context-binding identifiers of the initiating-device ephemeral public key and the responding-device ephemeral public key;
using the first symmetric key to decrypt the initiating-device encryption package to obtain the initiating-device signature and the initiating-device public-key certificate; and
authenticating the initiating device by:
verifying the cryptographic signature of the first trusted authority on the initiating-device public-key certificate with a public key of the first trusted authority; and
verifying the initiating-device signature using the initiating-device static public key from the initiating-device public-key certificate.

4. The method of claim 3, further comprising, at the responding device:
generating the responding-device signature;
calculating the second shared secret from the initiating-device static public key and the responding-device ephemeral secret key;
generating the second symmetric key based on (i) the first shared secret, (ii) the second shared secret, and (iii) context-binding identifiers of the initiating-device static public key, the initiating-device ephemeral public key, and the responding-device ephemeral public key;
generating the responding-device encryption package, including encrypting the responding-device encryption package with the second symmetric key; and
transmitting the responding-device encryption package to the initiating device.

5. The method of claim 4, further comprising, at the initiating device:
calculating a session shared secret from the responding-device static public key and the initiating-device static secret key;
generating a symmetric session key based on (i) the first shared secret, (ii) the session shared secret, and (iii) context-binding identifiers of the initiating-device static public key, the initiating-device ephemeral public key, the responding-device static public key, and the responding-device ephemeral public key; and
engaging in a secure communication session with the responding device using the symmetric session key.

6. The method of claim 5, further comprising, at the responding device:
calculating the session shared secret from the initiating-device static public key and the responding-device static secret key;
generating the symmetric session key based on (i) the first shared secret, (ii) the session shared secret, and (iii) context-binding identifiers of the initiating-device ephemeral public key, the initiating-device static public key, the responding-device ephemeral public key, and the responding-device static public key; and
engaging in the secure communication session with the initiating device using the symmetric session key.

7. The method of claim 6, wherein a context-binding identifier of a public key is a predetermined substring of the public key.

8. The method of claim 7, wherein the predetermined substring of the public key is a predetermined substring of a coordinate of the public key.

9. The method of claim 6, wherein:
the initiating device comprises a card reader for an access-control system; and
the responding device comprises an access card for the access-control system.

10. The method of claim 6, wherein:
the initiating device is implemented on a first mobile device; and
the responding device is implemented on a second mobile device.

11. A system comprising:
at least one hardware processor; and
one or more non-transitory computer readable storage media containing instructions that, when executed by the at least one hardware processor, cause the system to perform operations comprising, at an initiating device:
sending, to a responding device, an initiating-device ephemeral public key having a corresponding initiating-device ephemeral secret key at the initiating device, the initiating device further comprising an initiating-device static secret key and a corresponding initiating-device static public key;
receiving, from the responding device, a responding-device ephemeral public key having a corresponding responding-device ephemeral secret key at the responding device, the responding device further comprising a responding-device static secret key and a corresponding responding-device static public key;
generating an initiating-device signature that comprises a first value, the initiating-device ephemeral public key, and the responding-device ephemeral public key, the initiating-device signature being cryptographically signed with the initiating-device static secret key;
calculating a first shared secret from the responding-device ephemeral public key and the initiating-device ephemeral secret key;
generating a first symmetric key based on (i) the first shared secret and (ii) context-binding identifiers of the initiating-device ephemeral public key and the responding-device ephemeral public key;
generating an initiating-device encryption package comprising the initiating-device signature and an initiating-device public-key certificate, the initiating-device public-key certificate comprising the initiating-device static public key and a cryptographic signature of a first trusted authority, the initiating-device encryption package being encrypted with the first symmetric key; and
transmitting, to the responding device, the initiating-device encryption package.

12. The system of claim 11, the operations further comprising, at the initiating device:
receiving, from the responding device, a responding-device encryption package encrypted with a second symmetric key, the responding-device encryption package comprising a responding-device signature and a responding-device public-key certificate, the responding-device signature comprising a second value, the initiating-device ephemeral public key, and the responding-device ephemeral public key, the responding-device signature being cryptographically signed with the responding-device static secret key, the responding-device public-key certificate comprising the responding-device static public key and a cryptographic signature of a second trusted authority;
calculating a second shared secret from the responding-device ephemeral public key and the initiating-device static secret key;
generating the second symmetric key based on (i) the first shared secret, (ii) the second shared secret, and (iii) context-binding identifiers of the initiating-device static public key, the initiating-device ephemeral public key, and the responding-device ephemeral public key;
using the second symmetric key to decrypt the responding-device encryption package to obtain the responding-device signature and the responding-device public-key certificate; and
authenticating the responding device by:
verifying the cryptographic signature of the second trusted authority on the responding-device public-key certificate with a public key of the second trusted authority; and
verifying the responding-device signature using the responding-device static public key from the responding-device public-key certificate.

13. The system of claim 12, the operations further comprising, at the responding device:
receiving, from the initiating device, the initiating-device encryption package;
calculating the first shared secret from the initiating-device ephemeral public key and the responding-device ephemeral secret key;
generating the first symmetric key based on (i) the first shared secret and (ii) context-binding identifiers of the initiating-device ephemeral public key and the responding-device ephemeral public key;
using the first symmetric key to decrypt the initiating-device encryption package to obtain the initiating-device signature and the initiating-device public-key certificate; and
authenticating the initiating device by:
verifying the cryptographic signature of the first trusted authority on the initiating-device public-key certificate with a public key of the first trusted authority; and
verifying the initiating-device signature using the initiating-device static public key from the initiating-device public-key certificate.

14. The system of claim 13, the operations further comprising, at the responding device:
generating the responding-device signature;
calculating the second shared secret from the initiating-device static public key and the responding-device ephemeral secret key;
generating the second symmetric key based on (i) the first shared secret, (ii) the second shared secret, and (iii) context-binding identifiers of the initiating-device static public key, the initiating-device ephemeral public key, and the responding-device ephemeral public key;
generating the responding-device encryption package, including encrypting the responding-device encryption package with the second symmetric key; and
transmitting the responding-device encryption package to the initiating device.

15. The system of claim 14, the operations further comprising, at the initiating device:
calculating a session shared secret from the responding-device static public key and the initiating-device static secret key;
generating a symmetric session key based on (i) the first shared secret, (ii) the session shared secret, and (iii) context-binding identifiers of the initiating-device static public key, the initiating-device ephemeral public key, the responding-device static public key, and the responding-device ephemeral public key; and
engaging in a secure communication session with the responding device using the symmetric session key.

16. The system of claim 15, the operations further comprising, at the responding device:
calculating the session shared secret from the initiating-device static public key and the responding-device static secret key;
generating the symmetric session key based on (i) the first shared secret, (ii) the session shared secret, and (iii) context-binding identifiers of the initiating-device ephemeral public key, the initiating-device static public key, the responding-device ephemeral public key, and the responding-device static public key; and
engaging in the secure communication session with the initiating device using the symmetric session key.

17. The system of claim 16, wherein a context-binding identifier of a public key is a predetermined substring of the public key.

18. The system of claim 17, wherein the predetermined substring of the public key is a predetermined substring of a coordinate of the public key.

19. The system of claim 16, wherein:
the initiating device comprises a card reader for an access-control system; and
the responding device comprises an access card for the access-control system.

20. The system of claim 16, wherein:
the initiating device is implemented on a first mobile device; and
the responding device is implemented on a second mobile device.

21. One or more non-transitory computer readable storage media containing instructions that, when executed by at least one hardware processor of a first computing device, cause the first computing device to perform operations comprising:
sending, to a responding device, an initiating-device ephemeral public key having a corresponding initiating-device ephemeral secret key at the initiating device, the initiating device further comprising an initiating-device static secret key and a corresponding initiating-device static public key;
receiving, from the responding device, a responding-device ephemeral public key having a corresponding responding-device ephemeral secret key at the responding device, the responding device further comprising a responding-device static secret key and a corresponding responding-device static public key;
generating an initiating-device signature that comprises a first value, the initiating-device ephemeral public key, and the responding-device ephemeral public key, the initiating-device signature being cryptographically signed with the initiating-device static secret key;
calculating a first shared secret from the responding-device ephemeral public key and the initiating-device ephemeral secret key;
generating a first symmetric key based on (i) the first shared secret and (ii) context-binding identifiers of the initiating-device ephemeral public key and the responding-device ephemeral public key;
generating an initiating-device encryption package comprising the initiating-device signature and an initiating-device public-key certificate, the initiating-device public-key certificate comprising the initiating-device static public key and a cryptographic signature of a first trusted authority, the initiating-device encryption package being encrypted with the first symmetric key; and
transmitting, to the responding device, the initiating-device encryption package.

22-25. (canceled)
